(19) United States
(12) Patent Application Publication
(10) Pub. No.: US 2025/0085244 A1
(43) Pub. Date: Mar. 13, 2025

(54) METHOD AND SYSTEM FOR EVALUATING INSULATION PERFORMANCE OF LOW-TEMPERATURE STORAGE TANK

(71) Applicant: KOREA INSTITUTE OF MACHINERY & MATERIALS, Daejeon (KR)

(72) Inventors: Tae Hoon KIM, Daejeon (KR); Kyu Hyung DO, Daejeon (KR); Byung Il CHOI, Daejeon (KR); Yong Shik HAN, Daejeon (KR); Ae Jung YOON, Daejeon (KR); Hwa Long YOU, Busan (KR)

(21) Appl. No.: 18/550,615

(22) PCT Filed: Nov. 26, 2021
(86) PCT No.: PCT/KR2021/017650

§ 371 Date: Nov. 9, 2023

(30) Foreign Application Priority Data
Nov. 27, 2020 (KR) 10-2020-0163108

(51) Int. Cl. G01N 25/18

(52) U.S. Cl. CPC G01N 25/18

(57) ABSTRACT

The technology disclosed in the present specification is a method of evaluating insulation performance of a low-temperature storage tank, the method including an operation of transferring an internal electrode to a lower base material, wherein the operation includes: a first operation of measuring an amount of infrared energy of a sensor pad; a second operation of assuming a temperature of a substrate of the sensor pad as a specific value; a third operation of calculating a temperature of a first surface of the sensor pad by using the amount of the infrared energy measured from the sensor pad and the temperature of the substrate; a fourth operation of obtaining a temperature of the substrate from a transient heat conduction equation by using the temperature of the first surface as a boundary condition; a fifth operation of determining whether the obtained temperature of the substrate is equal to the assumed temperature of the substrate; and a sixth operation of, when the temperatures of the substrate are equal to each other, determining the calculated temperature of the first surface as a final temperature of the first surface and obtaining a value of heat flux infiltrating the low-temperature storage tank from the outside.

### TECHNICAL FIELD

The technology disclosed in the present specification relates to a method and a system for evaluating insulation performance of a low-temperature storage tank, and more particularly, to a method and a system for obtaining heat flux by attaching a sensor pad to a specific portion of a tank and measuring infrared energy emitted from the sensor pad with an infrared camera, so as to more precisely evaluate insulation performance of a low-temperature storage tank.

### BACKGROUND ART

To increase storage performance of low-temperature storage tanks, insulation performance of storage tanks is very important. When heat intrusion from the outside is not properly blocked, boil-off gas is generated in the storage tank and the pressure inside the storage tank increases. Therefore, it is necessary to release boil-off gas so as to properly maintain the pressure inside the storage tank. Accordingly, there is a problem in that a material stored in the storage tank is lost. Therefore, performance of the storage tank is directly associated with insulation performance, and there is a need for a method of precisely evaluating insulation performance so as to efficiently increase performance of the storage tank.

An existing method of evaluating insulation performance has been performed by measuring an amount of gas evaporated in a tank, and this was a method that only enabled evaluation of insulation performance of an entire low-temperature storage tank rather than a specific surface of a low-temperature storage tank. Therefore, because the existing method of evaluating insulation performance is unable to evaluate insulation performance of a local area, there is a disadvantage of being unable to specifically evaluate which specific portion of the low-temperature storage tank is vulnerable to insulation performance.

Therefore, in order to solve the problems of the existing evaluation method, there is an increasing need for a technology capable of evaluating insulation performance of a specific area and enabling more precise insulation performance evaluation.

### DISCLOSURE

### Technical Problem

The present disclosure aims to solve the problems described above and other problems associated therewith.

An exemplary objective of the present specification is to provide a method and a system for more precisely evaluating insulation performance of a specific area of a low-temperature storage tank by using a sensor pad attached to the specific area of the low-temperature storage tank, an infrared measurement device, and a processor that uses received data to calculate heat flux.

The technical objectives to be achieved by a method and a system for evaluating insulation performance of a low-temperature storage tank according to the technical idea of the technology disclosed in the present specification are not limited to the objectives for solving the problems described above, and other objectives that are not mentioned herein will be clearly understood from the following description by those of ordinary skill in the art.

### Technical Solution

A method of evaluating insulation performance of a low-temperature storage tank, according to an embodiment of the technology disclosed in the present specification, may include: a first operation of measuring an amount of infrared energy of a sensor pad; a second operation of assuming a temperature of a substrate of the sensor pad as a first temperature value; a third operation of calculating a temperature of a first surface of the sensor pad by using the amount of infrared energy measured from the sensor pad and the first temperature value; a fourth operation of obtaining a second temperature value of the substrate from a transient heat conduction equation by using the temperature of the first surface as a boundary condition; a fifth operation of determining whether the first temperature value is equal to the second temperature value; and a sixth operation of, when the first temperature value is equal to the second temperature value, determining the calculated temperature of the first surface as a final temperature of the first surface and obtaining a value of heat flux infiltrating the low-temperature storage tank from the outside.

The method may further include an operation of, when the first temperature value is not equal to the second temperature value in the fifth operation, changing the first temperature value and repeating the second to fifth operations.

In the method, the operation of measuring the amount of the infrared energy of the sensor pad may be performed with an infrared (IR) camera.

In the method, the substrate of the sensor pad may have an infrared transmittance of 95% or more and a thermal conductivity of 20 W/mK or less.

In the method, the entire first surface of the sensor pad may include an infrared black coating, and a portion of the second surface of the sensor pad may include an infrared black coating.

In the method, the infrared black coating may have an infrared transmittance of 5% or less.

A system for evaluating insulation performance of a low-temperature storage tank, according to another embodiment of the technology disclosed in the present specification, may include: a sensor pad attached to a low-temperature storage tank; an infrared measurement device configured to measure infrared energy of the sensor pad; and a processor, wherein the processor may be further configured to: receive an amount of the infrared energy measured from the sensor pad; and calculate a value of heat flux infiltrating the low-temperature storage tank from an outside by using the received amount of the infrared energy.

In the system, the processor may be configured to: assume a temperature of a substrate of the sensor pad as a first temperature value; calculate a temperature of a first surface of the sensor pad by using the amount of the infrared energy and the first temperature value; determine a final temperature of the first surface by repeating the assuming and calculating operations until a temperature of the substrate calculated by using the calculated temperature of the first surface is equal to the first temperature value; and calculate the value of the heat flux from the final temperature of the first surface.

In the system, the substrate of the sensor pad may have an infrared transmittance of 95% or more and a thermal conductivity of 20 W/mK or less.

In the system, the entire first surface of the sensor pad may include an infrared black coating, and a portion of the second surface of the sensor pad may include an infrared black coating.

In the system, the infrared black coating may have an infrared transmittance of 5% or less.

As another embodiment disclosed in the present specification, there may be provided a computer program stored in a medium including computer-readable instructions configured to execute respective operations of the method of evaluating insulation performance of the low-temperature storage tank.

The computer program may include: a first instruction for measuring an amount of infrared energy of a sensor pad; a second instruction for assuming a temperature of a substrate of the sensor pad as a first temperature value; a third instruction for calculating a temperature of a first surface of the sensor pad by using the amount of infrared energy measured from the sensor pad and the first temperature value; a fourth instruction for obtaining a second temperature value of the substrate from a transient heat conduction equation by using the temperature of the first surface as a boundary condition; a fifth instruction for determining whether the first temperature value is equal to the second temperature value; and a sixth instruction for, when the first temperature value is equal to the second temperature value, determining the calculated temperature of the first surface as a final temperature of the first surface and obtaining a value of heat flux infiltrating the low-temperature storage tank from the outside.

The computer program may further include an instruction for, when the first temperature value is not equal to the second temperature value in the fifth instruction, changing the first temperature value and repeating the second to fifth instructions.

The amount of the infrared energy of the sensor pad may be measured with an infrared camera.

The substrate of the sensor pad may have an infrared transmittance of 95% or more and a thermal conductivity of 20 W/mK or less.

The entire first surface of the sensor pad may include an infrared black coating, and a portion of the second surface of the sensor pad may include an infrared black coating.

The infrared black coating may have an infrared transmittance of 5% or more.

### Advantageous Effects

A method of evaluating insulation performance of a low-temperature storage tank, according to an embodiment of the technology disclosed in the present specification, has the following effects.

The present disclosure may provide a method of calculating the degree of heat flux infiltrating a low-temperature storage tank from the outside by using an infrared measurement device.

In addition, the method enables evaluation of insulation performance of a local area rather than overall average insulation performance of the low-temperature storage tank, and thus, has an effect of evaluating which specific portion of the low-temperature storage tank is vulnerable to insulation performance.

In addition, the present disclosure may be easily used to evaluate insulation performance of other objects as well as the low-temperature storage tank.

However, the effects according to an embodiment of the technology disclosed in the present specification are not limited to those described above, and other effects that are not mentioned herein will be clearly understood from the following description by those of ordinary skill in the art.

### DESCRIPTION OF DRAWINGS

Brief descriptions about the respective drawings are provided to gain a sufficient understanding of the drawings of the present specification.

FIG. 1 illustrates a system for implementing a method of evaluating insulation performance of a low-temperature storage tank according to an embodiment of the technology disclosed in the present specification.

FIG. 2 illustrates a detailed structure of a sensor pad disclosed in the present specification.

FIG. 3 illustrates an energy distribution of a sensor pad so as to describe the method of evaluating insulation performance, which is disclosed in the present specification.

FIG. 4 illustrates sequential operations of the method of evaluating insulation performance of a low-temperature storage tank.

### BEST MODE

As the technology disclosed in the present specification allows for various changes and numerous embodiments, certain embodiments will be illustrated in the drawings and described in detail in the written description. However, this is not intended to limit the technology disclosed in the present specification to specific embodiments, and it will be understood that the technology disclosed in the present specification includes all modifications, equivalents, and substitutes falling within the spirit and scope of the technology disclosed in the present specification.

In describing the technology disclosed in the present specification, when the detailed description of the relevant known technology is determined to unnecessarily obscure the gist of the technology disclosed in the present specification, the detailed description thereof is omitted herein. Also, numbers (e.g., first, second, etc.) used in the description of the present specification are merely identification symbols for distinguishing one element from another.

Also, in the present specification, when one element is referred to as being “connected” or “coupled” to another element, the one element may be directly connected or coupled to the other element, but it will be understood that the elements may be connected or coupled to each other via another element therebetween unless the context clearly indicates otherwise.

Also, an element represented by “unit” or “-er/or” in the present specification may be one element in which two or more elements are combined, or may be divided into two or more elements for each more subdivided function. Also, each of the elements to be described below may additionally perform, in addition to the main function thereof, some or all of the functions that other elements are responsible for, and some of the main functions that the respective elements are responsible for may be dedicated by other elements.

The expression “first,” “second,” etc. used in various embodiments may modify various elements regardless of order and/or importance, and does not limit the elements. For example, while not departing from the scope of the technology disclosed in the present specification, a first element may be referred to as a second element, and similarly, a second element may be referred to as a first element.

Hereinafter, a method and a system for evaluating insulation performance of a low-temperature storage tank, according to preferred embodiments, will be described in detail.

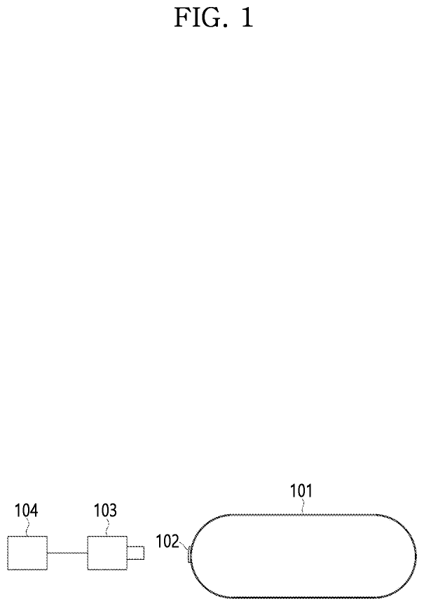

FIG. 1 illustrates a system for implementing a method of evaluating insulation performance of a low-temperature storage tank, which is disclosed in the present specification. The system according to the present disclosure may include a low-temperature storage tank 101, a sensor pad 102, an infrared measurement device 103, and a processor 104.

The low-temperature storage tank 101 according to the present disclosure may be a tank that stores low-temperature materials. For example, the low-temperature storage tank 101 may be a tank that stores low-temperature liquid or gas.

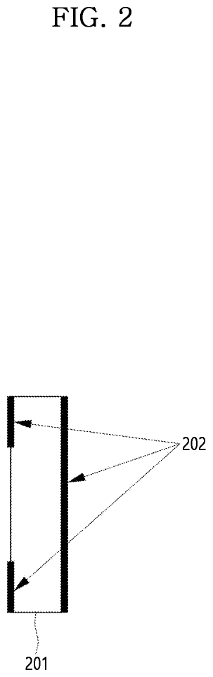

The sensor pad 102 according to the present disclosure may be configured to include three layers. For example, the sensor pad 102 may have a substrate as a middle layer, and a first surface of the substrate may include an infrared black coating. As an example, the entire first surface may include an infrared black coating. In addition, a second surface that is opposite to the first surface of the substrate may also include an infrared black coating. As an example, a portion of the second surface may include an infrared black coating. The detailed structure of the sensor pad 102 according to the present disclosure is described below with reference to FIG. 2.

FIG. 1 illustrates that the sensor pad 102 may be attached to a specific surface of the low-temperature storage tank 101. Because the sensor pad 102 is attached to the specific surface of the tank 101, the system capable of measuring heat flux of the specific surface rather than overall average heat flux of the tank 101 may be provided. The infrared measurement device 103 may measure infrared energy generated from the sensor pad. The infrared measurement device 103 may be an infrared camera. The processor 104 may calculate heat flux by using an infrared energy value received from the infrared measurement device 103. For example, the heat flux may refer to heat flux flowing from the outside of the tank with a high temperature to the inside of the tank with a relatively low temperature.

FIG. 2 illustrates the detailed structure of the sensor pad disclosed in the present specification.

In FIG. 2, the sensor pad 102 includes a substrate 201 and an infrared black coating 202. In the sensor pad 102 according to an embodiment, the entirety of one surface (the first surface) may include the infrared black coating 202, and a portion of the other surface (the second surface) may include the infrared black coating 202. The substrate 201 may be included in the sensor pad 102. The substrate 201 according to embodiment may have an infrared transmittance of 0.95 (95%) or more and a thermal conductivity of 20 W/mK or less. In addition, the infrared black coating 202 may have an infrared transmittance of 0.05 (5%) or less. The numerical ranges of the infrared transmittance and the thermal conductivity of the substrate 201 and the infrared transmittance of the infrared black coating 202 of the substrate 201 are one embodiment and are set for maximizing the efficiency of the method of evaluating insulation performance. The method of evaluating insulation performance may be implemented even within a range other than the set values. Therefore, the method of evaluating insulation performance is not limited to the set numerical ranges. In addition, the materials of the substrate 201 and the infrared black coating 202 are not limited to one specific material and may be one of materials that satisfy the conditions described above.

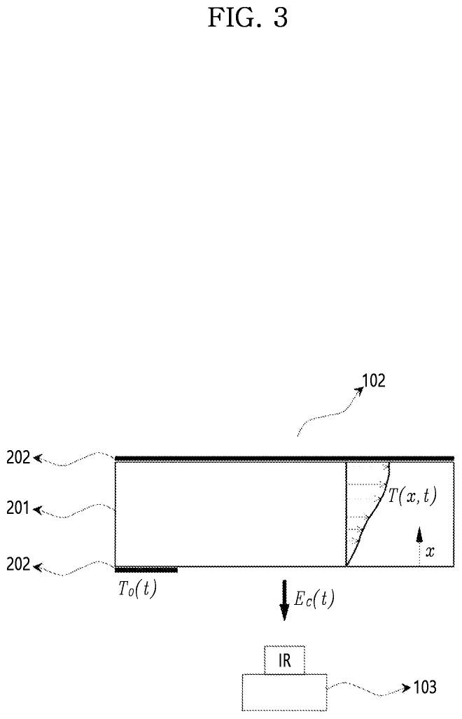

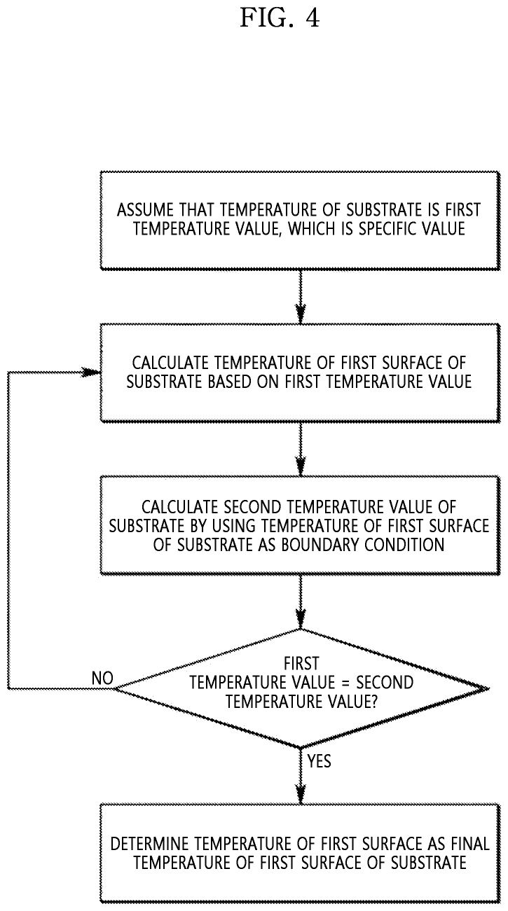

FIG. 3 illustrates an energy distribution of the sensor pad so as to describe the method of evaluating insulation performance, which is disclosed in the present specification, and FIG. 4 illustrates sequential operations of the method of evaluating insulation performance of the low-temperature storage tank.

Hereinafter, the method of evaluating insulation performance of the low-temperature storage tank, which is disclosed in the present specification, is described in detail with reference to FIGS. 3 and 4.

Referring to FIG. 3, the temperature of the substrate 201 may be represented by T(x, t), and the temperature of a portion of the surface of the sensor pad 102 including the infrared black coating may be represented by T₀(t). E_{c}(t) represents the amount of infrared energy emitted from the sensor pad 102.

The infrared measurement device 103 may measure E_{c}(t) that is the amount of infrared energy emitted from the sensor pad 102. Data measured by the infrared measurement device 103 may be transmitted to the processor 104, and the processor 104 may calculate heat flux flowing into the low-temperature storage tank by performing the following detailed operations.

In operation S401 of FIG. 4, it is assumed that the temperature T(x, tᵢ) of the substrate 201 is a first temperature value, which is a specific value. The heat flux to be measured by the method of evaluating insulation performance according to the present disclosure is heat flux of the entire surface (the entire first surface) including the infrared black coating in FIG. 3, but the data measured by the infrared measurement device 103 does not only represent infrared light emitted from the first surface. The data measured by the infrared measurement device 103 represents a value including both a portion where infrared light emitted from the first surface passes through the substrate and the infrared energy emitted from the substrate. Therefore, the data measured by the infrared measurement device 103 may be represented by a radiant energy equation as shown in Equation 1 below.

$${E}_{c} ( t ) = τ E [ {T}_{b} ( t ) ] + E [ T ( x , t ) ] \qquad [ Equation 1 ]$$

Next, in operation S402, the first temperature value T(x, tᵢ) of the substrate, which is assumed in operation S401, may be substituted into Equation 1 to calculate T_{b}(tᵢ), which is the temperature of the first surface.

In subsequent operation S403, Equation 2 below may be calculated by using the temperature T_{b}(tᵢ) of the first surface as a boundary condition (B.C.). Equation 2 below is used to numerically solve the governing equations related to heat conduction inside the substrate 201.

$$\frac{{\partial }^{2} T ( x , t )}{\partial {x}^{2}} = \frac{1}{α} \frac{\partial T ( x , t )}{\partial t} \qquad [ Equation 2 ]$$

$$B . C . \text{:} T ( L , t ) = {T}_{b} ( t ) , T ( 0 , t ) = {T}_{0} ( t )$$

As a result of calculating Equation 2 above according to the boundary condition (B.C.), the temperature distribution of the substrate 201 may be obtained, and the second temperature value of the substrate 201 may be obtained therefrom. As a result of calculating Equation 2 above according to the boundary condition (B.C.), the temperature distribution of the substrate 201 may be obtained, and the second temperature value of the substrate 201 may be obtained therefrom.

In operation S404, an operation of determining whether the second temperature value of the substrate 201 obtained in operation S403 is equal to the first temperature value of the substrate 201 assumed in operation S401. At this time, when both data are the same as each other, subsequent operation S405 is performed. When both data are not equal to each other, the process returns to operation S402 to repeat the same detailed operations on the assumption that the first temperature value of the substrate 201 is a new first temperature value.

In operation S405, the processor 104 may finally determine, as a final temperature of the first surface of the substrate 201, a value at which the first temperature value and the second temperature value are determined as the same value in operation S404, and may calculate heat flux according to Equation 3 below.

$$Heat Flux = {k}_{f} \frac{\partial T}{\partial x} {\vert}_{at black coating} \qquad [ Equation 3 ]$$

The heat flux values calculated from each operation may be used to evaluate insulation performance of a specific portion of the low-temperature storage tank 101, that is, a position at which the sensor pad 102 is attached. Accordingly, it is possible to efficiently determine which specific portion of the low-temperature storage tank 101 has poor insulation performance.

According to the present disclosure, a computer program including instructions associated with the execution of the methods may be further included in order to effectively control the methods described above. The computer program is stored in a data storage medium, and instructions for performing the methods described above are read through the processor of the computer according to set environments or values input by the user.

The computer program for evaluating insulation performance of the low-temperature storage tank, according to the present disclosure, may include a first instruction for measuring the amount of infrared energy of the sensor pad 102, a second instruction for assuming the temperature of the substrate 201 of the sensor pad 102 as the first temperature value, a third instruction for calculating the temperature of the first surface of the sensor pad 102 by using the amount of infrared energy measured from the sensor pad 102 and the first temperature value, a fourth instruction for obtaining the second temperature value of the substrate 201 from a transient heat conduction equation by using the temperature of the first surface as the boundary condition, a fifth instruction for determining whether the first temperature value is equal to the second temperature value, and a sixth instruction for, when the first temperature value is equal to the second temperature value, determining the calculated temperature of the first surface as the final temperature of the first surface and obtaining the value of heat flux infiltrating the low-temperature storage tank 101 from the outside.

The computer program may further include an instruction for, when the first temperature value is not equal to the second temperature value in the fifth instruction, changing the first temperature value and repeating the second to fifth instructions.

The amount of infrared energy of the sensor pad 102 may be measured by using an infrared camera 103.

The substrate 201 of the sensor pad 102 may have an infrared transmittance of 95% or more and a thermal conductivity of 20 W/mK or less.

In the sensor pad 102, the entire first surface of the sensor pad 102 may include the infrared black coating 202, and a portion of the second surface of the sensor pad 102 may include the infrared black coating 202.

The infrared black coating 202 may have an infrared transmittance of 5% more less.

The methods and controls thereof described above may be implemented as a hardware component, a software component, and/or a combination of the hardware component and the software component. For example, the methods and elements described in the embodiments may be implemented by using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processor may execute an operating system (OS) and one or more software applications running on the OS. Additionally, the processor may access, store, operate, process, and generate data in response to the execution of software. For ease of understanding, one processor has been described as being used in some cases, but those of ordinary skill in the art will appreciate that the processor may include multiple processing elements and/or multiple types of processing elements. For example, the processor may include multiple processors or one processor and one controller. In addition, other processing configurations such as a parallel processor are possible.

The software may include a computer program, code, instructions, or a combination of one or more thereof, and may configure a processor to operate as desired or may instruct the processor independently or collectively. The software and/or data may be interpreted by the processor. Alternatively, in order to provide instructions or data to the processor, the software and/or data may be embodied permanently or temporarily in any type of machine, element, physical device, virtual device, computer storage medium or device. The software may be distributed over networked computer systems and stored or executed in a distributed manner. The software and data may be stored on one or more computer-readable recording media.

The methods according to embodiments may be implemented in the form of program commands that are executable through a variety of computer means and may be recorded on a computer-readable recording medium. The computer-readable medium may include program commands, data files, data structures, etc. alone or in combination. The program commands recorded on the medium may be those specially designed and configured for the embodiments or those known to and usable by those of ordinary skill in computer software. Examples of the computer-readable recording medium may include magnetic media such as hard disk, floppy disk, and magnetic tape, optical media such as compact disc read-only memory (CD-ROM) and digital versatile disc (DVD), magneto-optical media such as floptical disk, and hardware devices specially configured to store and execute program commands, such as read-only memory (ROM), random access memory (RAM), and flash memory. Examples of the program commands may include not only machine language codes generated by a compiler, but also high-level language codes that are executable using an interpreter by a computer. The hardware device described above may be configured to operate as one or more software modules so as to perform the operations of the embodiments, and vice versa.

As described above, although the embodiments have been described with reference to the restrictive embodiments and drawings, various modifications and variations may be made thereto from the above description by those of ordinary skill in the art. For example, appropriate results may be achieved even when the technologies described above are performed in an order different from the methods described above, and/or components of the systems, structures, devices, or circuits described above are coupled or combined in a manner different from the methods described above or are replaced or substituted for other components or equivalents.

Therefore, other implementations, other embodiments, and equivalents of the claims also fall within the scope of the claims described below.

1. A method of evaluating insulation performance of a low-temperature storage tank, the method comprising:
a first operation of measuring an amount of infrared energy of a sensor pad;
a second operation of assuming a temperature of a substrate of the sensor pad as a first temperature value;
a third operation of calculating a temperature of a first surface of the sensor pad by using the amount of infrared energy measured from the sensor pad and the first temperature value;
a fourth operation of obtaining a second temperature value of the substrate from a transient heat conduction equation by using the temperature of the first surface as a boundary condition;
a fifth operation of determining whether the first temperature value is equal to the second temperature value; and
a sixth operation of, when the first temperature value is equal to the second temperature value, determining the calculated temperature of the first surface as a final temperature of the first surface and obtaining a value of heat flux infiltrating the low-temperature storage tank from the outside.

2. The method of claim 1, further comprising an operation of, when the first temperature value is not equal to the second temperature value in the fifth operation, changing the first temperature value and repeating the second to fifth operations.

3. The method of claim 1, wherein the operation of measuring the amount of the infrared energy of the sensor pad is performed with an infrared (IR) camera.

4. The method of claim 1, wherein the substrate of the sensor pad has an infrared transmittance of 95% or more and a thermal conductivity of 20 W/mK or less.

5. The method of claim 1, wherein the entire first surface of the sensor pad includes an infrared black coating, and a portion of the second surface of the sensor pad includes an infrared black coating.

6. The method of claim 5, wherein the infrared black coating has an infrared transmittance of 5% or less.

7. A system for evaluating insulation performance of a low-temperature storage tank, the system comprising:
a sensor pad attached to a low-temperature storage tank;
an infrared measurement device configured to measure infrared energy of the sensor pad; and
a processor,
wherein the processor is configured to:
receive an amount of the infrared energy measured from the sensor pad; and
calculate a value of heat flux infiltrating the low-temperature storage tank from an outside by using the received amount of the infrared energy.

8. The system of claim 7, wherein the processor is further configured to:
assume a temperature of a substrate of the sensor pad as a first temperature value;
calculate a temperature of a first surface of the sensor pad by using the amount of the infrared energy and the first temperature value;
determine a final temperature of the first surface by repeating the assuming and calculating operations until a temperature of the substrate calculated by using the calculated temperature of the first surface is equal to the first temperature value; and
calculate the value of the heat flux from the final temperature of the first surface.

9. The system of claim 7, wherein the substrate of the sensor pad has an infrared transmittance of 95% or more and a thermal conductivity of 20 W/mK or less.

10. The system of claim 7, wherein the entire first surface of the sensor pad includes an infrared black coating, and a portion of the second surface of the sensor pad includes an infrared black coating.

11. The system of claim 10, wherein the infrared black coating has an infrared transmittance of 5% or less.

12. A computer program for evaluating insulation performance of a low-temperature storage tank, the computer program comprising:
a first instruction for measuring an amount of infrared energy of a sensor pad;
a second instruction for assuming a temperature of a substrate of the sensor pad as a first temperature value;
a third instruction for calculating a temperature of a first surface of the sensor pad by using the amount of infrared energy measured from the sensor pad and the first temperature value;
a fourth instruction for obtaining a second temperature value of the substrate from a transient heat conduction equation by using the temperature of the first surface as a boundary condition;
a fifth instruction for determining whether the first temperature value is equal to the second temperature value; and
a sixth instruction for, when the first temperature value is equal to the second temperature value, determining the calculated temperature of the first surface as a final temperature of the first surface and obtaining a value of heat flux infiltrating the low-temperature storage tank from the outside.

13. The computer program of claim 12, further comprising an instruction for, when the first temperature value is not equal to the second temperature value in the fifth instruction, changing the first temperature value and repeating the second to fifth instructions.

14. The computer program of claim 12, wherein the amount of the infrared energy of the sensor pad is measured with an infrared camera.

15. The computer program of claim 12, wherein the substrate of the sensor pad has an infrared transmittance of 95% or more and a thermal conductivity of 20 W/mK or less.

16. The computer program of claim 12, wherein the entire first surface of the sensor pad includes an infrared black coating, and a portion of the second surface of the sensor pad includes an infrared black coating.

17. The computer program of claim 16, wherein the infrared black coating has an infrared transmittance of 5% or more.
